(19) United States
(12) Patent Application Publication
(10) Pub. No.: US 2006/0196212 A1
(43) Pub. Date: Sep. 7, 2006

(54) Water delivery system with water flow sensor for a refrigerator

(75) Inventors: James H. Jenkins JR., South Amana, IA (US); William James Vestal, Milan, IL (US)

Correspondence Address: DIEDERIKS & WHITELAW, PLC, 12471 Dillingham Square, #301, Woodbridge, VA, 22192, US

(73) Assignee: Maytag Corp.

(21) Appl. No.: 11/072,430

(22) Filed: Mar. 7, 2005

(51) Int. Cl. F25C 1/00; B67D 5/62

(52) U.S. Cl. 62/340; 62/389

(57) ABSTRACT

A water delivery system for delivering water to a water dispenser or an icemaker of a refrigerator includes a water inlet adapted to be connected to a fresh water supply, a water outlet connected to at least one of a water dispenser and an icemaker, and a flow sensor in fluid communication between the water supply and water outlet for generating flow signals which are used by a controller to determine flow rate and flow volume parameters for the system. The water delivery system also preferably includes a filter positioned between the water inlet and the flow sensor. The determined flow parameters are used for indicating a need for a filter change and to regulate the volume of water flowing to the water dispenser and/or icemaker.

### BACKGROUND OF THE INVENTION

1. Field of the Invention

The present invention pertains to the art of refrigerators and, more particularly, to a water delivery system incorporating a water flow sensor in a refrigerator.

2. Discussion of the Invention

Providing water dispensers and automatic icemakers in household refrigerators has become extremely commonplace. In addition, there is a growing trend toward increasing the purity of all consumed water. For at least these reasons, it has heretofore been proposed in the art to incorporate a water purifying system in a refrigerator in order to filter the water supplied to a water dispenser and/or icemaker. Early proposed purifying systems of this type centered around providing a filtering unit between the water supply and the conduit entering the refrigerator. These systems were typically installed by service personnel as aftermarket add-on units. More recently, it has been proposed to incorporate filter assemblies during the overall manufacturing of refrigerators, while utilizing filters which can be fairly, readily accessed for replacement directly by consumers.

The filter assemblies have a limited life span and must be replaced, generally after a given number of gallons have been filtered, in order to maintain the quality of the filtered water. It is often difficult to estimate the amount of water filtered by a particular filter assembly. Therefore, there exists a need to monitor the amount of water that has flowed through the filter assembly and to notify a customer when the filter's capacity has been reached.

In addition, many refrigerators include water dispensing systems having control panels for allowing users to select desired amounts of water to be dispensed. However, the amount of water selected may not correspond to the amount of water actually dispensed due to factors such as variations in household water pressure. Variations in water pressure also affect the amount of water flowing to an icemaker. Therefore, ice cube size may not be consistent. Based on the above, there also exists a need in the art for an enhanced water dispensing system for a refrigerator, particularly a dispensing system that ensures a selected volume of water will be dispensed irrespective of variables such as household water pressure.

### SUMMARY OF THE INVENTION

The present invention is directed to a water delivery system, including a flow sensor, for delivering water to a water dispenser or an icemaker in a refrigerator. In accordance with a preferred embodiment of the invention, the water delivery system includes a water inlet adapted to be connected to fresh water supply and a water outlet connected to at least one of a water dispenser and an icemaker. The flow sensor, which is positioned between the water inlet and water outlet, outputs signals which are used to establish flow rate and volume parameters by a controller. The water delivery system preferably includes a filter positioned between the water inlet and the flow sensor. If the water flow rate falls below a predetermined level, the controller generates an output indicating a problem with the water delivery system. In this manner, the controller establishes an indication of when the filter needs to be replaced based on the amount of water that flows past the sensor. The controller is also coupled to a selection device operative to allow a user to control the volume of water flowing to the icemaker for varying ice cube size.

Additional objects, features and advantages of the water delivery system of the invention will become more readily apparent from the following detailed description of a preferred embodiment, when taken in conjunction with the drawings wherein like reference numerals refer to corresponding parts in the several views.

### BRIEF DESCRIPTION OF THE DRAWINGS

FIG. 1 is a perspective view of a side-by-side refrigerator incorporating a water delivery system constructed in accordance with the present invention;

FIG. 2 is an exploded view of the water delivery system of the invention; and

FIG. 3 is a block diagram of a control arrangement employed in connection with the invention.

### DETAILED DESCRIPTION OF THE PREFERRED EMBODIMENT

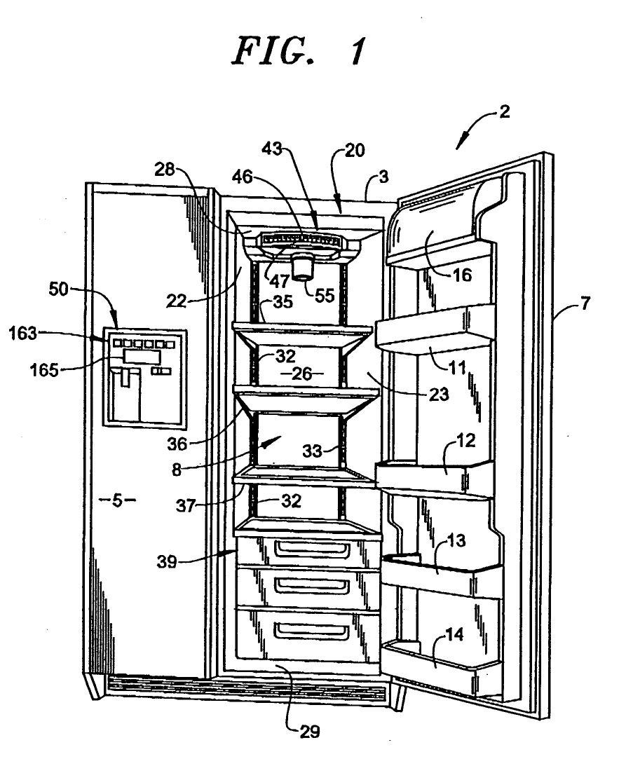

With initial reference to FIG. 1, a side-by-side refrigerator is generally indicated at 2. In a manner widely known in the art, a side-by-side refrigerator 2 is formed from a cabinet shell 3 to which is pivotably attached a freezer compartment side door 5 and a fresh food compartment side door 7. Side door 7 is shown open to expose a fresh food compartment 8 defined within cabinet shell 3. Fresh food compartment side door 7 supports a plurality of vertically spaced shelves 11-14 and is also preferably provided with a dairy compartment 16. In a preferred embodiment, fresh food compartment 8 is formed from an integral liner 20 having opposed side walls 22 and 23, a rear wall 26 and top and bottom walls 28 and 29. Secured to rear walls 26 by means of mechanical fasteners (not shown) are a pair of laterally spaced and vertically extending rails 32 and 33 that adjustably support various vertically spaced shelves 35-37, as well as a shelf supporting bin assembly generally indicated at 39.

Also shown mounted within fresh food compartment 8 at top wall 28 is a temperature control unit 43. Temperature control unit 43 is preferably molded of plastic and includes upper and lower slidable temperature control members 46 and 47 which can be used by a consumer to adjust the temperatures within side-by-side refrigerator 2 to preferable levels. As also shown in this figure, freezer compartment side door 5 is preferably provided with a dispensing unit 50 which can be used to selectively dispense either water or ice.

In general, the above-described structure of side-by-side refrigerator 2 is known in the art and does not form part of the present invention. Instead, this description is provided for the sake of completeness. The present invention is particularly directed to a water delivery system having a flow sensor for supplying water either directly to dispensing unit 50 or to an automatic icemaker. Also included in the water delivery system is a replaceable filter, generally indicated at 55 in FIG. 1, which forms part of the water delivery system of the present invention. As shown, filter cartridge 55 preferably projects downward from within the housing of temperature control unit 43 at a central rear portion of fresh food compartment 8. This location is utilized in accordance with the preferred embodiment to provide a readily visible and easily accessible filter cartridge 55 that can be replaced by a consumer as needed. However, other locations for replaceable filter 55 could be employed.

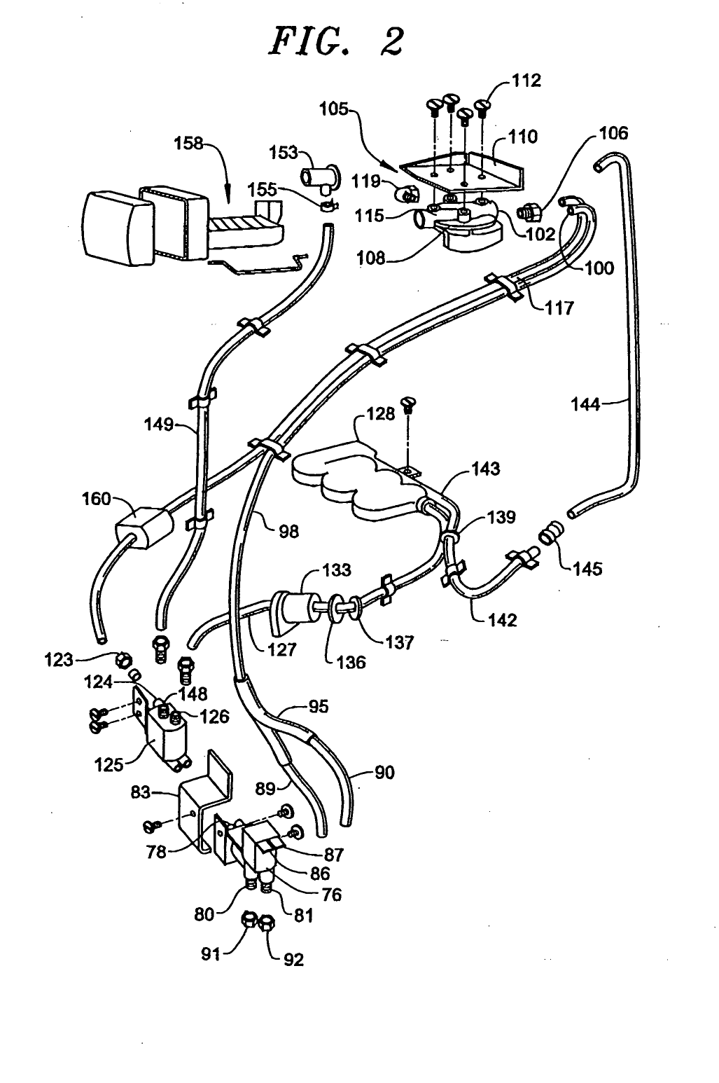

Reference will now be made to FIG. 2 in detailing the overall components and their interconnections for the water delivery system of the present invention. In accordance with the preferred form of the invention, a water supply (not shown) is attached to refrigerator 2 at dual valve 76. More specifically, dual valve 76 includes an inlet 78 for attachment of the supply line, as well as first and second outlets 80 and 81. Dual valve 76 is attached to refrigerator 2 by means of bracket 83 and preferably constitutes a solenoid-type valve having electrical connectors 86 and 87 which can be utilized to fluidly interconnect inlet 78 to one or more of the first and second outlets 80 and 81 in the manner which will be described more fully below. Outlets 80 and 81 are respectively connected to first and second water delivery tubes 89 and 90, preferably through the use of compression nuts 91 and 92. First and second water delivery tubes 89 and 90 converge by means of a Y-connector 95 into a common water delivery tube 98. Tube 98 has a terminal end 100 that is connected to a water inlet 102 of a filter cartridge mounting head 105 through a connector 106.

Filter cartridge mounting head 105 is used to support filter cartridge 55 and therefore it is preferably mounted such that at least a portion of the housing of temperature control unit 43 encloses filter cartridge mounting head 105. In any event, mounting head 105 includes a main body 108 which is preferably injection molded of plastic and attached to a bracket 110 by means of various screws 112. In addition to water inlet 102, mounting head 105 has associated therewith a water outlet 115 to which is attached a tube 117 by means of an elbow connector 119. Tube 117 is preferably formed from plastic and 0.25 inches in diameter. The manner in which water flows through mounting head 105 from tube 98 to tube 117 will be detailed more fully below. An opposing end of tube 117 is connected through a fitting 123 to an inlet port 124 of a dispenser valve 125. Dispenser valve 125 includes a first outlet 126 which is connected through a conduit 127 that leads to a water tank 128. In a manner known in the art, water tank 128 is preferably mounted within fresh food compartment 8, such as at lower rear portion thereof. Preferably, dispenser valve 125 is a solenoid-type valve having electrical connectors 29 and 30.

Since both valves 76 and 125 are preferably located outside of fresh food compartment 8, conduit 127 has positioned therealong a spacer 133 that extends through liner 20 to permit sealing around conduit 127 during the injection molding of foamed insulation within cabinet 3 in a manner widely known in the art. For additional sealing purposes, seals 136, 137 and 139 are also provided. Seal 139 is actually associated with a tube 142 that leads from water tank 128. More specifically, tube 142 includes a first section 143 that is interconnected to a second section 144 through a connector 145. Second section 144 of tube 142 directly leads to the fountain of water dispensing unit 50. Dispenser valve 125 also includes a second outlet 148 to which is attached a tube 149 that leads to a nozzle 153. More specifically, tube 149 is attached to nozzle 153 by means of a clamp 155 and nozzle 153 is utilized to provide a flow of water to an icemaker generally indicated at 158.

With this arrangement, water supplied to refrigerator 2 is first delivered to valve 76. Whether icemaker 158 or the fountain associated with dispensing unit 50 requires water will determine which side of dual valve 76 is actuated, thereby controlling the connection between the first and second water delivery tubes 89 and 90 with the flow into inlet 78. Mounting head 105 normally has filter cartridge 55 attached thereto, such that water would flow into inlet 102 through common tube 98, would be forced to flow through filter cartridge 55 and would be delivered to a water outlet 115. The filtered water would then be delivered through tube 117 to dispenser valve 125 which would regulate whether the water would flow to water tank 128 and then dispenser unit 50 or to icemaker 158.

Two valves 76 and 125 are utilized to control the flow of water in the overall water circuit. These multiple valves are utilized in order to separate the electrical nodes and allow the water to flow to its desired source. However, there are various other types of water circuit arrangements which could be devised to perform this function, such as utilizing a valve in place of dual valve 76 which has a single input and output in combination with dispenser valve 125. The disclosed embodiment is preferred since a single signal received from either the dispenser unit 50 or icemaker 158 can be used to control both valves 76 and 125 such that the water is routed in the desired path. In any case, all of the water for either the dispensing unit 50 or icemaker 158 is directed through mounting head 105 and, so long as the consumer has attached a suitable filter cartridge 55, the purity of the water delivered to either dispensing unit 50 or icemaker 158 will be enhanced.

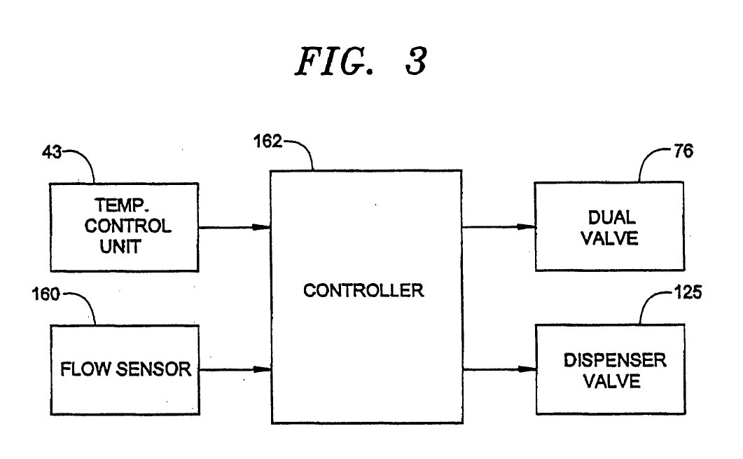

At this point it should be noted that the overall configuration of the water delivery system as described above is known in the art as set forth in U.S. Pat. No. 6,303,031 which is incorporated herein by reference. Therefore, this discussion has been included for the sake of completeness. The present invention is more particularly directed to the inclusion and use of a flow sensor 160 in the overall water delivery system. As shown, flow sensor 160 is preferably positioned along tube 117, between filter cartridge 55 and dispensing valve 125. Flow sensor 160 is preferably a turbine meter. A signal generated by flow sensor 160 is sent to an electronic controller 162 (see FIG. 3). Controller 162 utilizes signals from flow sensor 160 to determine both an accumulated flow volume and a flow rate based on the volume of water that passes through flow sensor 160 in a predetermined period of time.

Typically, the flow rate of water passing through the water delivery system varies from about 10-20 cc/sec., depending on the water inlet pressure, which ranges from about 20-120 psi. By sensing the flow rate, controller 162 can be used to determine how long dispensing valve 125 should be opened to dispense the selected amount of water. For example, controller 162 may signal dispensing valve 125 to close after 140 cc+/−10 cc has passed through flow sensor 160. Although controller 162 can regulate the flow of water in various ways, the most preferred embodiment of the invention has controller 162 electrically linked to contacts 129 and 130 of dispensing valve 125 for this purpose. The following table demonstrates how adjusting dispensing time allows a consistent amount of water to be dispensed (135 cc) regardless of inlet pressure.

| Actual Amount | Dispense time | Flow rate | Inlet Pressure |
|---|---|---|---|
| (cc) | (sec.) | (cc/sec.) | (psi) |
| 135.5 | 9.0 | 15 | 41.5 |
| 135.5 | 8.7 | 15 | 41.5 |
| 136.0 | 8.7 | 15 | 41.5 |
| 135.2 | 8.8 | 15 | 41.0 |
| 135.2 | 24.0 | 5 | 9.0 |
| 135.0 | 24.5 | 5 | 8.5 |
| 135.2 | 24.3 | 5 | 8.5 |
| 135.0 | 8.1 | 16 | 120.0 |
| 135.3 | 8.1 | 16 | 120.0 |
| 135.2 | 8.0 | 16 | 120.0 |
| 136.0 | 8.0 | 17 | 119.5 |

The following table indicates the differences in fill amounts due to inlet pressure in a water dispensing system without a flow sensor versus the present water delivery system including flow sensor 160.

| Water Inlet | Fill Amount | Fill Amount |
|---|---|---|
| Pressure (psi) | without sensor (cc) | with sensor (cc) |
| 9.0 | | 135.1 |
| 20.0 | 81.0 | |
| 30.0 | 108.0 | |
| 40.0 | 129.0 | 135.7 |
| 60.0 | 139.0 | |
| 80.0 | 143.0 | |
| 100.0 | 145.0 | |
| 120.0 | 141.0 | 135.5 |

In accordance with the invention, a consumer may advantageously vary the size of ice cubes made in icemaker 158 by adjusting the fill amount. Since the fill amount is regulated based on signals provided by flow sensor 160, the selected ice cube size will be consistent. Similarly, a specific amount of water can be selected to be dispensed from dispensing unit 50 regardless of the inlet pressure. For example, a consumer may select a fill amount of 4 oz., 8 oz., etc. Preferably, these adjustments are made through a series of buttons 163 or directly through a display 165 provided on dispensing unit 50 (see FIG. 1).

Although flow sensor 160 may be used in water dispensing systems that do not include filter cartridge 55, employing flow sensor 160 in combination with filter 55 provides many advantages. For instance, through the use of flow sensor 160, the total amount of water that has passed through filter 55 is preferably recorded, with this information being conveyed to a consumer by controller 162 and display 165. With this arrangement, a consumer will know exactly when to change filter 55 based on the amount of usage. Flow sensor 160 is also capable of detecting when filter 55 needs to be changed due to clogging. More specifically, a baseline flow rate is preferably recorded when a new filter cartridge is installed. When the flow rate drops below a predetermined level, a signal will be generated to notify the consumer that filter 55 needs to be changed.

A change filter indicator (not individually shown) is preferably located in display 165 or elsewhere. In accordance with a preferred embodiment of the invention, an indicator is provided in the form of an amber light that is illuminated in display 165 to notify a consumer that filter 55 needs to be changed soon. More specifically, the indicator includes a red light to notify the consumer when it is immediately necessary to change the filter. Most preferably, the indicator indicates a “% of filter life remaining” based on water usage pattern. To this end, signals from flow sensor 160 may also be used to record the overall amount of water that passes through the system or the average use over a specific period of time.

The inclusion of flow sensor 160 in accordance with the invention also provides a number of diagnostic benefits, such as notifying a consumer when a low water flow condition exists due to low water pressure or downstream water leaks. Downstream water leaks may occur due to an improper door hinge connection or an icemaker fill tube leak. A lack of water in the flow system may also occur if the water supply is not connected properly. In any case, water flow sensor 160 sends information to controller 162 which can shut down the system and notify the consumer of such conditions. Signals from flow sensor 160 can also be used to lock out icemaker 158 when water dispensing unit 50 is in use so that consumer selected fill amounts are not affected by the simultaneous use of water.

Based on the above, it should be readily apparent that various changes and/or modifications can be made to the present invention without departing from the spirit thereof. Certainly, although described with reference to a side-by-side refrigerator, the water dispensing system and flow sensor of the invention could be used on various styles of refrigerators. In addition, although the preferred embodiment alters the water flow time through the system by controlling whether a single valve is opened or closed, this function could be performed in other ways, such as by controlling an adjustable flow characteristic associated with one or more variable position valves. Furthermore, the flow sensor of the invention could be employed in conjunction with other overall refrigerator water dispensing systems, including both single and dual control valve arrangements. In any event, the invention is only intended to be limited by the scope of the following claims.

We claim:

1. A refrigerator comprising:
at least one of a water dispenser and an icemaker;
a system for delivering water to the at least one of the water dispenser and the icemaker, said water delivering system including:
a water inlet adapted to be connected to a water supply;
at least one water outlet fluidly connected to the at least one of the water dispenser and the icemaker;
a valve interposed between the water supply and the at least one water outlet for regulating an actual amount of water flowing to the at least one water outlet; and
a flow sensor positioned between the water inlet and at least one water outlet for sensing a flow of water in the system and generating flow signals; and
a controller linked to each of the valve and the flow sensor, said controller regulating the valve based on the flow signals received from the flow sensor to regulate the actual amount of water flowing to the at least one of the water dispenser and the icemaker.

2. The refrigerator according to claim 1, further comprising: means for allowing a consumer to selectively adjust a desired volume of water to be automatically dispensed through the water delivering system.

3. The refrigerator according to claim 2, wherein the at least one of the water dispenser and the icemaker constitutes a water dispenser, wherein the allowing means is used to select a predetermined amount of water to be automatically dispensed from the water dispenser.

4. The refrigerator according to claim 2, wherein the at least one of the water dispenser and the icemaker constitutes an icemaker, wherein the allowing means is used to selectively alter a size of ice cubes made by the icemaker.

5. The refrigerator according to claim 1, further comprising: a filter positioned between said water inlet and the at least one of the water dispenser and the icemaker, said controller signaling a need to change the filter based on the flow signals received from the flow sensor.

6. The refrigerator according to claim 1, wherein the controller determines both accumulated flow volume and flow rate parameters based on the flow signals from the flow sensor.

7. The refrigerator according to claim 6, further comprising: a filter positioned between said water inlet and the at least one of the water dispenser and the icemaker, said controller providing an indication when the filter needs to be replaced based on the accumulated flow parameter.

8. The refrigerator according to claim 6, wherein the controller provides an indication when the flow rate parameter falls below a predetermined level.

9. The refrigerator according to claim 1, wherein the controller automatically regulates the valve to maintain a substantially consistent flow through the system over time.

10. A method of delivering water to at least one of a water dispenser or an icemaker in a refrigerator comprising:
sensing a flow of water between a water supply inlet and a water outlet through a flow sensor; and
altering a flow of water through a dispensing valve based on flow signals received from the flow sensor to regulate the actual amount of water flowing to the at least one of the water dispenser and the icemaker.

11. The method of claim 10, further comprising: automatically providing an indication when the flow rate falls below a predetermined level.

12. The method of claim 10, further comprising:
filtering the flow of water through a filter; and
providing an indication to change the filter based on an accumulated flow volume determined by the flow signals.

13. The method of claim 10, further comprising:
manually selecting a predetermined amount of water to be dispensed; and
subsequently, automatically dispensing the predetermined amount of water.

14. The method of claim 10, further comprising: altering a size of ice cubes made by the icemaker by altering the flow of water through the dispensing valve.

15. The method of claim 10, further comprising: determining both accumulated flow volume and flow rate parameters based on flow signals from the flow sensor.

16. The method of claim 10, further comprising: automatically regulating the valve to maintain a substantially consistent rate of flow through the water outlet over time.

17. A method of enabling a consumer to alter a size of ice cubes produced by an icemaker in a refrigerator comprising:
sensing a flow of water delivered to the icemaker;
permitting a consumer to manually set a change in a desired size for ice cubes produced by the icemaker; and
altering the flow of water delivered to the icemaker to establish the desired size for the ice cubes.

18. The method of claim 17, further comprising: automatically providing an indication when the flow of water falls below a predetermined rate.

19. The method of claim 17, further comprising: automatically regulating the flow of water to maintain a substantially consistent rate of flow to the icemaker over time when no change in the desired size for the ice cubes is set.

20. The method of claim 17, further comprising:
filtering the flow of water through a filter; and
providing an indication to change the filter based on an accumulated flow volume to the icemaker.
